(19) United States
(12) Patent Application Publication
(10) Pub. No.: US 2026/0264734 A1
(43) Pub. Date: Sep. 10, 2026

(54) CONVEYANCE AUXILIARY DEVICE

(71) Applicant: JTEKT MACHINE SYSTEMS CORPORATION, Yao-shi, Osaka (JP)

(72) Inventor: Hiroki OE, Yao-shi, Osaka (JP)

(73) Assignee: JTEKT MACHINE SYSTEMS CORPORATION, Yao-shi, Osaka (JP)

(21) Appl. No.: 19/167,438

(22) PCT Filed: Mar. 6, 2024
(86) PCT No.: PCT/JP2024/008578

§ 371 Date: Sep. 22, 2025

(30) Foreign Application Priority Data
Mar. 22, 2023 (JP) 2023-045915

(51) Int. Cl. B62B 5/00; A61G 7/08; B60B 19/00; B62B 3/00

(52) U.S. Cl. CPC B62B 5/0043; A61G 7/08; B60B 19/003; B62B 3/00; B62B 2301/25

(57) ABSTRACT

A transport assistance apparatus includes first and second mecanum wheels, first and second motors, first and second current sensors that detect induced currents flowing through the motors when the mecanum wheels rotate, and a controller. The controller individually estimates accelerations of the mecanum wheels based on the detected induced currents, determines a moving direction of a bed based on the estimated accelerations, and operates the first and second mecanum wheels to assist the movement of the bed in the moving direction.

### TECHNICAL FIELD

The present disclosure relates to a transport assistance apparatus.

### BACKGROUND ART

For example, Patent Document 1 discloses an auxiliary propulsion system using mecanum wheels in a drive unit. The auxiliary propulsion system includes a pair of mecanum wheels connected to a chassis, motors that respectively drive the mecanum wheels, and a control system that senses changes in the rotational speed of each motor.

According to Patent Document 1 described above, when moving the chassis in a predetermined direction, the operator applies a force in the same direction. As each mecanum wheel is rotated by the applied force, an associated change in rotational speed is reported to the control system. The control system starts electric rotation of the motors based on the report. The electric rotation assists the movement of the chassis.

### CITATION LIST

### Patent Document

Patent Document 1: Japanese Unexamined Patent Publication No. 2016-525977

### SUMMARY OF THE INVENTION

### Technical Problem

When the configuration described in Patent Document 1 is adopted, it is required to appropriately determine the moving direction of a target for better assistance. Although a force sensor such as a strain gauge and a piezoelectric force sensor can be attached to the target for such determination, there is still room for improvement to make more appropriate determination.

The present disclosure has been made in view of the above circumstances, and an object thereof is to provide better assistance of a movement of a target.

### Solution to the Problem

A first aspect of the present disclosure relates to a transport assistance apparatus for assisting a movement of a target made by an external force. The transport assistance apparatus includes: a first mecanum wheel and a second mecanum wheel that are attached to the target; a first motor and a second motor that are respectively connected to the first mecanum wheel and the second mecanum wheel to drive the first mecanum wheel and the second mecanum wheel; a first current sensor that detects an induced current flowing through the first motor when the first mecanum wheel rotates, and a second current sensor that detects an induced current flowing through the second motor when the second mecanum wheel rotates; and a controller that controls the first and second motors. The controller individually estimates accelerations of the first and second mecanum wheels based on detection signals of the first and second current sensors, determines a moving direction of the target based on the accelerations of the first and second mecanum wheels, and drives the first and second mecanum wheels via the first and second motors to assist a movement of the target in the moving direction.

According to the first aspect, detecting the induced current allows estimating torque that causes the induced current (the torque that causes the mecanum wheel to rotate), and thus, allows estimating the acceleration corresponding to the torque. The sign of the induced current corresponds to the sign of the estimated acceleration, and can be associated with the rotation direction of each wheel.

When a plurality of mecanum wheels is used, the rotation direction of each wheel can be associated with a translation direction of the entire transport assistance apparatus. The translational direction of the entire transport assistance apparatus is considered to substantially coincide with the direction in which the external force acts, and thus, the moving direction of the target. Based on the rotation directions of the wheels, the moving direction of the target can be determined. By assisting the movement in the determined moving direction, the actual rotation statuses of the mecanum wheels are reflected, providing better assistance.

For the detection of the acceleration as described above, a six-axis sensor can be used, for example. However, the six-axis sensor is generally sensitive to vibration. If the mecanum wheels are configured or attached in a different manner, or if the target is a bed and a sleeper turns over the bed, for example, the detection value of the sensor significantly varies, which is inconvenient for accurately determining the direction. In contrast, when the induced current is used for the determination as in the present disclosure, the direction can be determined more accurately.

According to a second aspect of the present disclosure, the first mecanum wheel may include a first wheel body that rotates about a first rotation axis and a plurality of first barrel-shaped rollers arranged along an outer periphery of the first wheel body and rotating about a first inclined axis inclined with respect to the first rotation axis, and the second mecanum wheel may include a second wheel body that rotates about a second rotation axis extending parallel to the first rotation axis and a plurality of second barrel-shaped rollers arranged along an outer periphery of the second wheel body and rotating about a second inclined axis inclined in a direction different from the first inclined axis with respect to the second rotation axis.

According to the second aspect, the translational direction of the entire transport assistance apparatus can be made different between when both the first and second mecanum wheels rotate in the same direction and when the first and second mecanum wheels rotate in different directions. The rotation directions of the wheels are clearly distinguished from each other according to the translational direction, allowing more accurate determination of the moving direction of the target. This is advantageous in providing better assistance in moving the target.

According to the third aspect of the present disclosure, both the first and second rotation axes may extend in a left-right direction that is orthogonal to a front-rear direction of the target and extends parallel to a conveyance surface on which the target travels, and the first inclined axis may be inclined to be line-symmetrical with the second inclined axis with respect to the front-rear direction.

According to the third aspect, when both the first and second mecanum wheels rotate in the same direction, the entire transport assistance apparatus translates in the front-rear direction. When one of the first and second mecanum wheels rotates in a direction different from the other, the entire transport assistance apparatus translates in the left-right direction. The rotation directions of the wheels during the front-rear movement and the rotation directions of the wheels during the left-right movement are clearly distinguished from each other, allowing more accurate determination of the moving direction of the target. This is advantageous in providing better assistance in moving the target.

According to a fourth aspect of the present disclosure, the controller may calculate a difference between the acceleration of the first mecanum wheel and the acceleration of the second mecanum wheel, and may determine the moving direction based on a magnitude of the difference.

According to the fourth aspect, when both the first and second mecanum wheels rotate in the same direction (i.e., during the translation in the front-rear direction), the difference is substantially zero. When the first and second mecanum wheels rotate in different directions, the difference is significantly larger than zero. The difference during the front-rear movement and the difference during the left-right movement are clearly distinguished from each other, allowing more accurate determination of the moving direction of the target. This is advantageous in providing better assistance in moving the target.

According to a fifth aspect of the present disclosure, the controller may determine whether the moving direction is the front-rear direction based on the accelerations of the first and second mecanum wheels, and may command rotational speeds of the first and second mecanum wheels so that both the first and second mecanum wheels rotate forward or rearward when it is determined that the moving direction is the front-rear direction, and when commanding the rotational speeds, may make absolute values of the commanded rotational speeds of the first and second mecanum wheels equal to each other.

According to the fifth aspect, the absolute values of the commanded rotational speeds are made equal to each other for the front-rear movement, allowing more stable front-rear movement regardless of the orientation of the target. This is advantageous in providing better assistance in moving the target.

According to a sixth aspect of the present disclosure, the controller may determine whether the moving direction is the left-right direction based on the accelerations of the first and second mecanum wheels, and may command rotational speeds of the first and second mecanum wheels so that one of the first and second mecanum wheels rotates forward and the other rotates rearward when it is determined that the moving direction is the left-right direction, and when commanding the rotational speeds, may make absolute values of the commanded rotational speeds of the first and second mecanum wheels equal to each other.

According to the sixth aspect, the absolute values of the commanded rotational speeds are made equal to each other for the left-right movement, allowing more stable left-right movement regardless of the orientation of the target. This is advantageous in providing better assistance in moving the target.

According to a seventh aspect of the present disclosure, the target may be a bed with casters, and the first and second mecanum wheels may be attached to a lower portion of the bed with casters.

According to the seventh aspect, the target is a bed with casters. The present disclosure can also provide better assistance in moving a heavy object such as a bed with casters.

### Advantages of the Invention

As described above, the present disclosure can provide better assistance in moving a target.

### BRIEF DESCRIPTION OF THE DRAWINGS

FIG. 1 is a side view illustrating a general configuration of a transport assistance apparatus and a bed with casters.

FIG. 2 is a bottom view illustrating the general configuration of the transport assistance apparatus and the bed with casters.

FIG. 3 is a perspective view illustrating the configuration of the transport assistance apparatus.

FIG. 4 is a plan view illustrating the configuration of the transport assistance apparatus.

FIG. 5 is a side view illustrating the configuration of the transport assistance apparatus.

FIG. 6 is a block diagram illustrating a configuration of a control system of the transport assistance apparatus.

FIG. 7 is a view illustrating how first and second mecanum wheels move.

FIG. 8 is a view illustrating a detection target of a six-axis sensor.

FIG. 9 is a flowchart of a major process performed by a controller.

FIG. 10 is a flowchart of a process related to the determination of a moving direction.

FIG. 18 is a flowchart illustrating safety limit control.

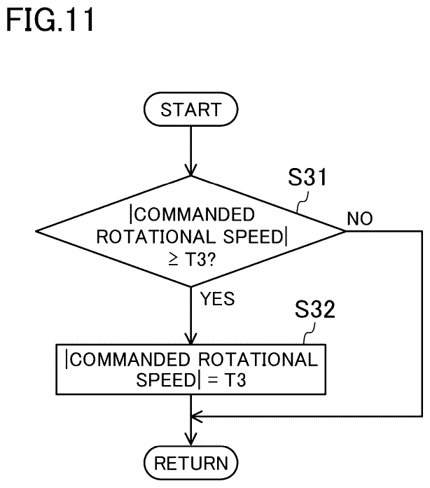

### DESCRIPTION OF EMBODIMENTS

An embodiment of the present disclosure will be described below with reference to the drawings.

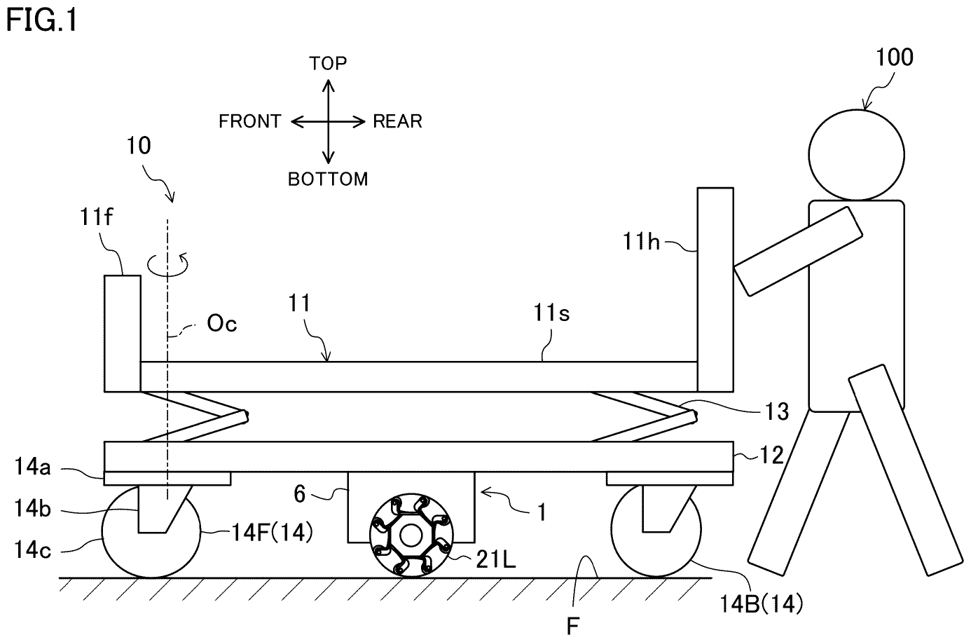

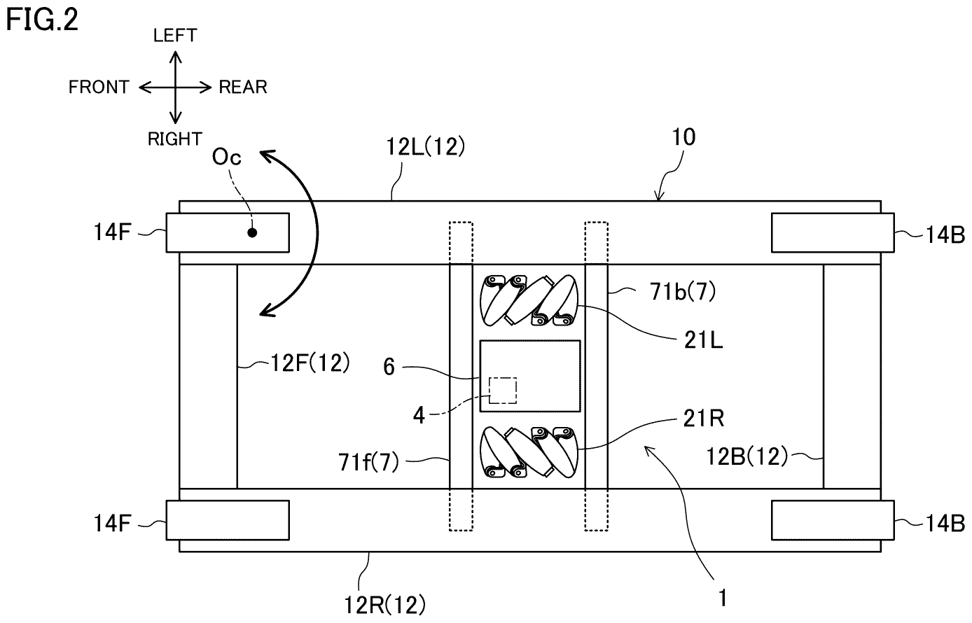

FIG. 1 is a side view illustrating a general configuration of a transport assistance apparatus 1 and a caster bed 10, and FIG. 2 is a bottom view illustrating the general configuration of the transport assistance apparatus 1 and the caster bed 10.

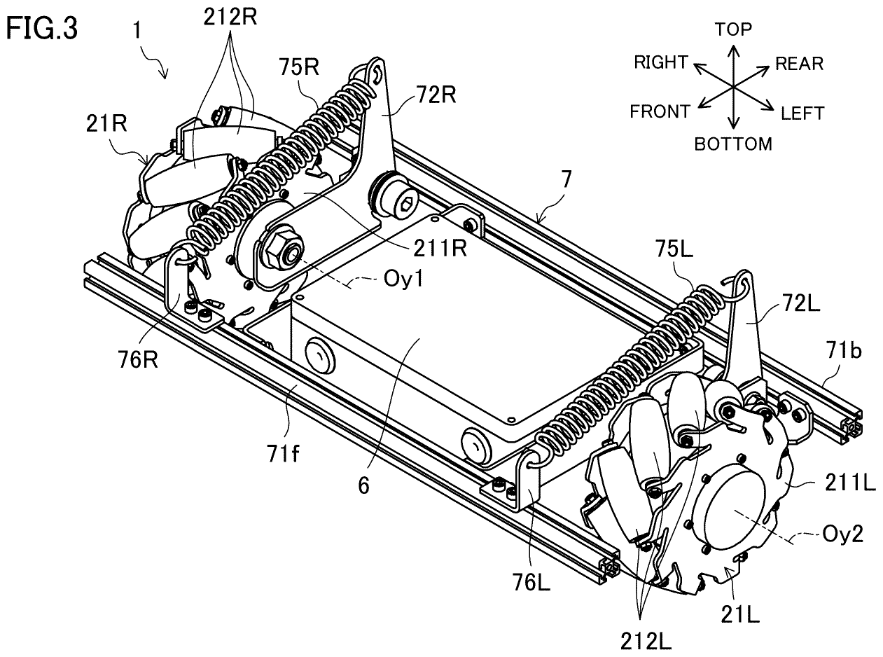

FIGS. 3, 4 and 5 are perspective, plan, and side views illustrating the configuration of the transport assistance apparatus 1.

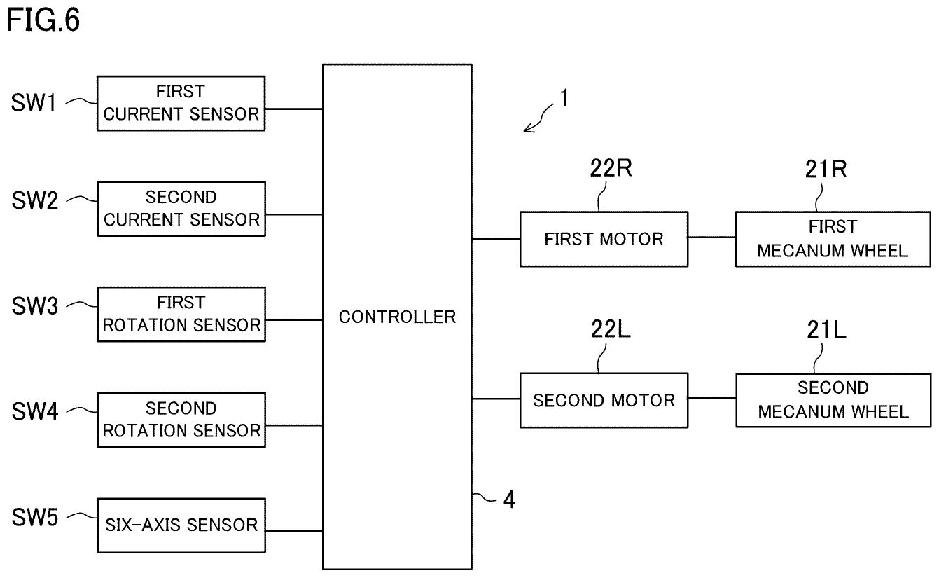

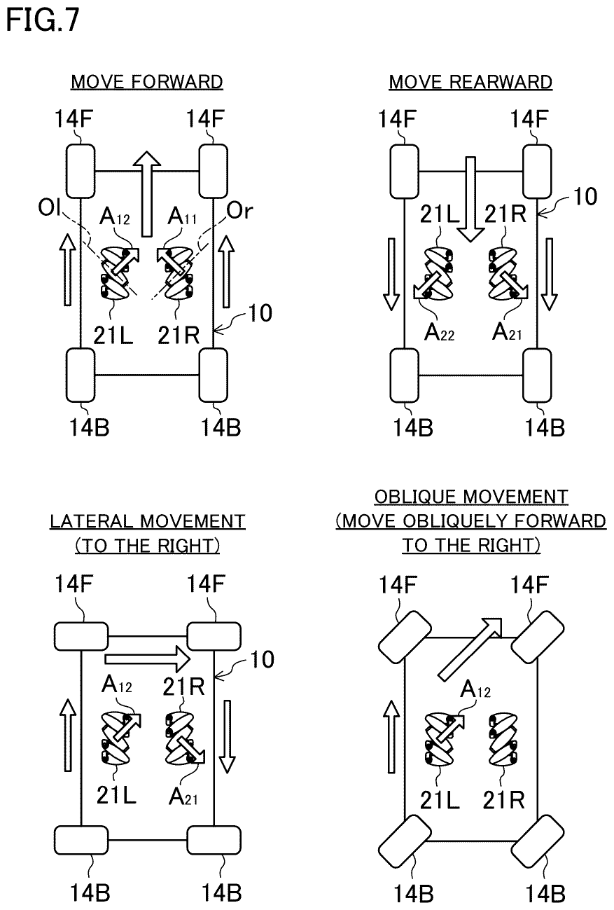

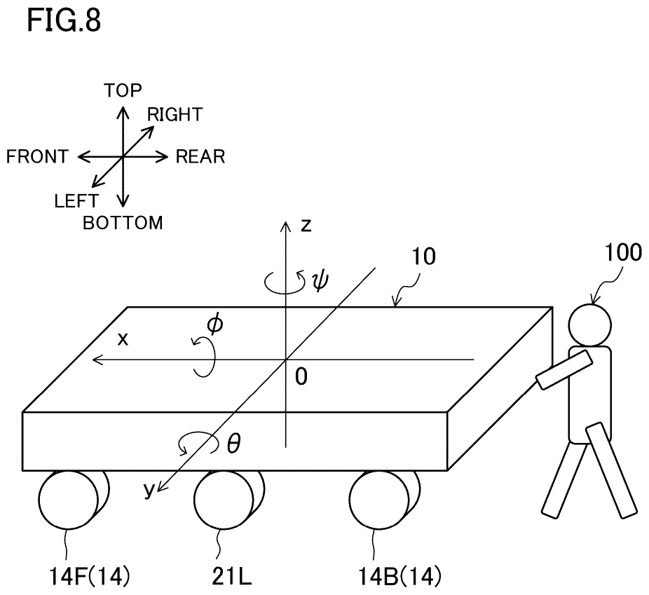

FIG. 6 is a block diagram illustrating the configuration of a control system of the transport assistance apparatus 1, and FIG. 7 is a view illustrating how first and second mecanum wheels 21R and 21L move. FIG. 8 is a view illustrating a detection target of a six-axis sensor SW5.

The transport assistance apparatus 1 is attached to a given target. The transport assistance apparatus 1 assists a movement of the target by an external force (e.g., an external force applied by a transporter 100).

As shown in FIGS. 1 and 2, the target according to the present embodiment is a bed 10 with casters (hereinafter simply referred to as a “bed”). The bed 10 includes a plurality of casters 14 including front casters 14F and rear casters 14B, and is used as a medical bed, for example.

Hereinafter, a lengthwise direction of the bed 10, that is, a direction in which a person lies on the bed 10 is referred to as a “front-rear direction” or a “longitudinal direction,” a direction toward the toes of the person in the front-rear direction is referred to as the “front,” and a direction toward the head of the person is referred to as the “rear.”

Similarly, a widthwise direction of the bed 10, that is, a direction orthogonal to the front-rear direction on a horizontal plane is defined as a “left-right direction” or a “lateral direction,” a direction toward the back of the paper of FIG. 1 in the left-right direction is defined as the “right,” and a direction toward the front of the paper of FIG. 1 is defined as the “left” (see FIG. 2 for details). The “left-right direction” referred to herein means the left-right direction when the bed is viewed from the back side toward the front side. In the following description, a “lateral movement” refers to a movement in the left-right direction. The left-right direction (lateral direction) can also be defined as a direction that is orthogonal to the front-rear direction and extends along a transport surface F (a floor surface on which the bed 10 travels).

One end of the bed 10 in the front-rear direction (e.g., a rear end in the illustrated example) is supported by the transporter 100. The transport assistance apparatus 1 operates to assist the transporter 100 supporting the bed 10 to push the bed 10 by hand.

As shown in FIG. 1, the bed 10 includes a bed body 11 on which a mattress (not shown) is placed, a frame 12 that supports the bed body 11 from below, a lifter 13 that raises and lowers the bed body 11 with respect to the frame 12, and a plurality of casters 14 (four casters in the illustrated example) arranged on the bottom of the bed 10. When used as a medical bed, the bed 10 weighs, for example, 60 kg or more and 300 kg or less.

The bed body 11 includes a headboard 11h arranged at a rear end of the bed 10, a footboard 11f arranged at a front end opposite to the rear end in the front-rear direction, and side rails 11s arranged on the left and right sides of the bed 10.

The headboard 11h is supported from the rear side by the transporter 100 to move the bed 10 by hand. The headboard 11h serves as a support to which a force is applied by the transporter 100. A member such as a handle or a grip may be attached to or integrated with the headboard 11h so that the member is used as the support. The footboard 11f or the side rails 11s may be used as the support.

As shown in FIG. 2, the frame 12 is formed in a rectangular frame shape, and includes four sides consisting of a front frame 12F, a right frame 12R, a left frame 12L, and a rear frame 12B.

The front frame 12F is arranged on the front side of the bed 10 and extends in the left-right direction. The right frame 12R is arranged on the right side of the bed 10 and extends in the front-rear direction. The left frame 12L is arranged on the left side of the bed 10 and extends in the front-rear direction. The rear frame 12B is arranged on the rear side of the bed 10 and extends in the left-right direction.

As shown in FIGS. 1 and 2, the front casters 14F and the rear casters 14B constituting the casters 14 are arranged at four corners of the bottom of the bed 10. Two front casters 14F are arranged in the left-right direction, and two rear casters 14B are also arranged in the left-right direction. The casters 14 support the frame 12, the lifter 13, and the bed body 11 with respect to the transport surface F.

Each caster 14 is a so-called free caster, and includes a mount 14a fixed to the bottom of the bed 10, a fork 14b that can swivel about a swivel axis Oc relative to the mount 14a, and a wheel 14c rotatably supported by the fork 14b. The swivel axis Oc of each fork 14b extends vertically (along the height of the bed 10). A rotation axis of each wheel 14c extends along a horizontal plane. The rotation axis is inclined with respect to the left-right direction when the fork 14b swivels relative to the mount 14a.

The transport assistance apparatus 1 is arranged to span a middle portion of the right frame 12R in the front-rear direction and a middle portion of the left frame L in the front-rear direction. The transport assistance apparatus 1 is arranged between the front casters 14F and the rear casters 14B in the front-rear direction and at the center of the bed 10 in the left-right direction.

As shown in FIGS. 1 to 6, the transport assistance apparatus 1 includes a housing box 6, a fixture 7, first and second mecanum wheels 21R and 21L, first and second motors 22R and 22L, a controller 4, first and second current sensors SW1 and SW2, first and second rotation sensors SW3 and SW4, and a six-axis sensor SW5 (the first and second motors 22R and 22L and the sensors SW1 to SW5 are shown only in FIG. 6). It is assumed that, of the first and second mecanum wheels 21R and 21L, the first mecanum wheel 21R is located on the right, and the second mecanum wheel 21L is located on the left.

Among these components, the controller 4 and the six-axis sensor SW5 are contained in the housing box 6, and the fixture 7, the first and second mecanum wheels 21R and 21L, the first and second motors 22R and 22L, the first and second current sensors SW1 and SW2, and the first and second rotation sensors SW3 and SW4 are arranged outside the housing box 6.

The housing box 6 contains the controller 4 as described above. The housing box 6 is arranged between the first mecanum wheel 21R and the second mecanum wheel 21L in the left-right direction.

The housing box 6 is assembled to the fixture 7 together with the first and second mecanum wheels 21R and 21L, and is attached to the lower portion of the bed 10 with the fixture 7. The fixture 7 is detachably attached to the lower portion of the bed 10. That is, the transport assistance apparatus 1 of the present embodiment can be retrofitted to the bed 10 and can be removed as necessary.

Specifically, as shown in FIGS. 2 to 5, the fixture 7 of the present embodiment includes a front rail member 71f, a rear rail member 71b, a first arm member 72R that rotatably supports the first mecanum wheel 21R, and a second arm member 72L that rotatably supports the second mecanum wheel 21L.

The front rail member 71f and the rear rail member 71b are spaced in the front-rear direction, and each of the front rail member 71f and the rear rail member 71b spans a central portion of the right frame 12R in the front-rear direction and a central portion of the left frame 12L in the front-rear direction. The front rail member 71f and the rear rail member 71b are detachably attached to the right frame 12R and the left frame 12L. The first and second mecanum wheels 21R and 21L and the housing box 6 are arranged between the front rail member 71f and the rear rail member 71b in the front-rear direction.

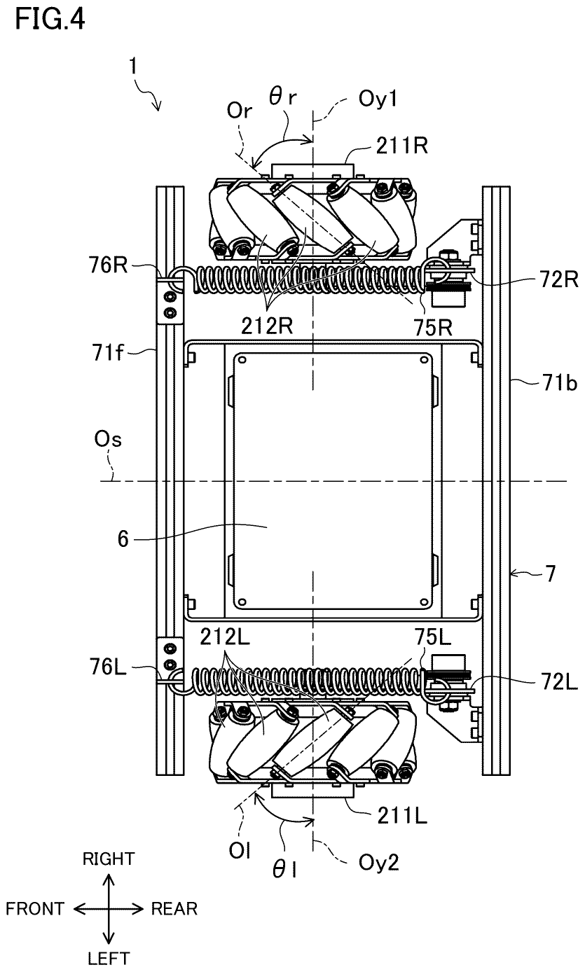

The first arm member 72R on the right side in FIGS. 3 and 4 is swingably supported by the rear rail member 71b. A front end portion of the first arm member 72R rotatably supports the first mecanum wheel 21R. The first arm member 72R is arranged between the first mecanum wheel 21R and the housing box 6 in the left-right direction.

One end of a first tension spring 75R is locked to an upper end portion of the first arm member 72R. The other end of the first tension spring 75R is locked to a first bracket 76R fixed to the front rail member 71f.

The second arm member 72L on the left side in FIGS. 3 and 4 is swingably supported by the rear rail member 71b, similarly to the first arm member 72. A front end portion of the second arm member 72L rotatably supports the second mecanum wheel 21L. The second arm member 72L is arranged between the second mecanum wheel 21L and the housing box 6 in the left-right direction.

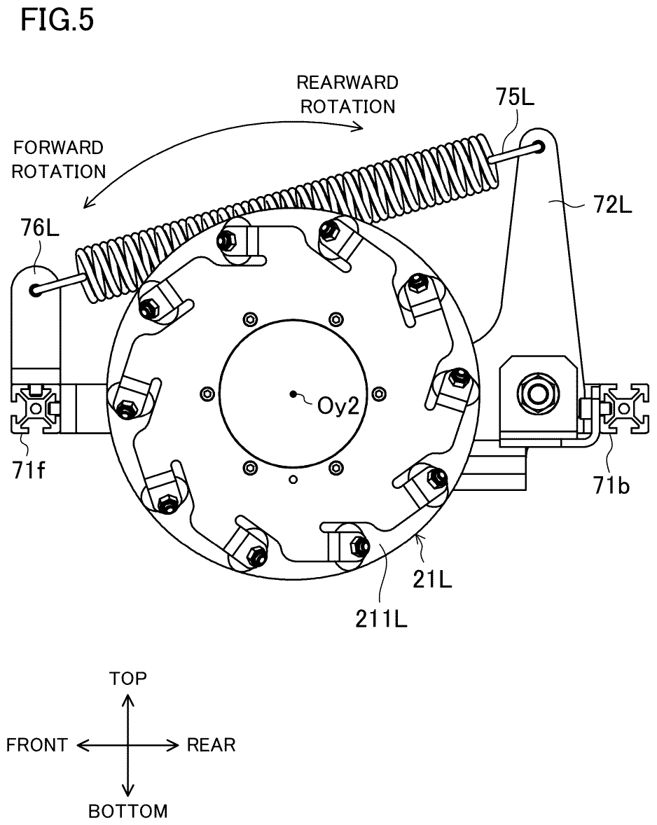

One end of a second tension spring 75L is locked to an upper end portion of the second arm member 72L. The other end of the second tension spring 75L is locked to a second bracket 76L fixed to the front rail member 71f (see also FIG. 5).

As shown in FIGS. 1 and 2, the first and second mecanum wheels 21R and 21L are attached to a lower portion (bottom) of the bed 10. The first and second mecanum wheels 21R and 21L are in contact with the transport surface F on which the bed 10 travels. The transport surface F is shown only in FIG. 1. The first and second mecanum wheels 21R and 21L are arranged behind the front casters 14F and in front of the rear casters 14B. In the present embodiment, the first and second mecanum wheels 21R and 21L are arranged side by side in the left-right direction which is the widthwise direction, as shown in FIG. 2.

Specifically, as shown in FIGS. 3 to 5, the first mecanum wheel 21R includes a first wheel body 211R that rotates about a first rotation axis Oy1 and a plurality of first barrel-shaped rollers 212R that are arranged along an outer periphery of the first wheel body 211R and rotate about a first inclined axis Or inclined with respect to the first rotation axis Oy1.

The second mecanum wheel 21L includes a second wheel body 211L that rotates about a second rotation axis Oy2 and a plurality of second barrel-shaped rollers 212L that are arranged along an outer periphery of the second wheel body 211L and rotate about a second inclined axis Ol inclined in a direction different from the first inclined axis Or with respect to the second rotation axis Oy2.

Both the first and second rotation axes Oy1 and Oy2 extend in the left-right direction. The first inclined axis Or is inclined to be line-symmetrical with the second inclined axis Ol with respect to the front-rear direction (see a symmetry axis Os shown in FIG. 4). In other words, suppose that a plane extending in the vertical direction and the front-rear direction is a mirror plane, the first inclined axis Or and the second inclined axis Ol extend to be mirror-symmetrical with respect to the mirror plane.

When viewed from above as shown in FIG. 4 (when viewed in plan), the first and second inclined axes Or and Ol extend from the inside to the outside in the left-right direction (from the center portion in the left-right direction to the right or the left) as they extend from the rear side to the front side in the front-rear direction.

Specifically, the first inclined axis Or extends from the center portion to the right in the left-right direction as it extends from the rear side to the front side in the front-rear direction. The second inclined axis Ol extends from the center portion to the left in the left-right direction as it extends from the rear side to the front side in the front-rear direction.

More specifically, an inclination angle θr of the first inclined axis Or with respect to the first rotation axis Oy1 is 45° in plan view. Similarly, an inclination angle θ1 of the second inclined axis Ol with respect to the second rotation axis Oy2 is also 45° in plan view. The direction and angle of inclination of each of the barrel-shaped rollers 212R and 212L are not limited to these examples. For example, the entire transport assistance apparatus 1 shown in FIG. 2 may be rotated by a predetermined angle about a z-axis extending in the vertical direction.

As described above, the first and second mecanum wheels 21R and 21L are mutually connected via the front rail member 71f and the rear rail member 71b shown in FIG. 3 and some other drawings. Thus, the first and second mecanum wheels 21R and 21L integrally move in the front-rear direction and the left-right direction and integrally turn around a turning axis perpendicular to a horizontal plane.

The first and second motors 22R and 22L are respectively connected to the first and second mecanum wheels 21R and 21L to drive the first and second mecanum wheels 21R and 21L. In particular, each of the first and second motors 22R and 22L is configured as a so-called three-phase DC brushless motor. Both the first and second motors 22R and 22L are electrically connected to the controller 4, and are controlled by the controller 4.

A motor current corresponding to a torque load is supplied to each of the first and second motors 22R and 22L to rotate them. The motor current can change the rotational speeds of the first and second motors 22R and 22L, and can achieve switching between the forward and reverse rotations.

The first motor 22R is connected to the first mecanum wheel 21R to be able to transmit a driving force (torque) to the first mecanum wheel 21R. The second motor 22L is connected to the second mecanum wheel 21L to be able to transmit a driving force (torque) to the second mecanum wheel 21L.

When the first motor 22R rotates, the driving force is transmitted to rotate the first mecanum wheel 21R. Similarly, when the second motor 22L rotates, the driving force is transmitted to rotate the second mecanum wheel 21L.

In the present embodiment, the forward rotation of the first motor 22R rotates the first mecanum wheel 21R forward, and the reverse rotation of the first motor 22R rotates the first mecanum wheel 21R rearward. Similarly, in the present embodiment, the forward rotation of the second motor 22L rotates the second mecanum wheel 21L forward, and the reverse rotation of the second motor 22L rotates the second mecanum wheel 21L rearward.

The first motor 22R is incorporated in the first mecanum wheel 21R, and the second motor 22L is incorporated in the second mecanum wheel 21L. Incorporating the first and second motors 22R and 22L in this manner makes the entire transport assistance apparatus 1 simple and compact.

Specifically, the first current sensor SW1 detects an induced current flowing through the first motor 22R when the first mecanum wheel 21R rotates. That is, when the first mecanum wheel 21R rotates upon receiving an external force, a rotor and stator of the first motor 22R relatively rotate, generating an induced current. The induced current detected by the first current sensor SW1 corresponds to a q-axis current.

The magnitude of the induced current is proportional to the torque acting on the first mecanum wheel 21R when the first mecanum wheel 21R rotates upon receiving the external force. The magnitude of the torque is associated with the magnitude of the external force applied to the bed 10, and thus, to the amount of change in speed of the bed 10 due to the external force. In addition, the sign of the induced current is associated with the direction in which the first mecanum wheel 21R rotates upon receiving the external force. The sign of the induced current is opposite to the motor current that flows when the first motor 22R is driven.

The second current sensor SW2 detects an induced current flowing through the second motor 22L when the second mecanum wheel 21L rotates. That is, when the second mecanum wheel 21L rotates upon receiving the external force, a rotor and stator of the second motor 22L relatively rotate, generating an induced current. The induced current detected by the second current sensor SW2 corresponds to a q-axis current.

The magnitude of the induced current is proportional to the torque acting on the second mecanum wheel 21L when the second mecanum wheel 21L rotates upon receiving the external force. The magnitude of the torque is associated with the magnitude of the external force applied to the bed 10, and thus, to the amount of change in speed of the bed 10 due to the external force. The sign of the induced current is associated with the direction in which the second mecanum wheel 21L rotates upon receiving the external force. The sign of the induced current is opposite to the motor current that flows when the second motor 22L is driven.

For example, when the first mecanum wheel 21R rotates forward upon receiving the external force and the second mecanum wheel 21L rotates rearward at the same time, the first current sensor SW1 detects an induced current with the same sign as the induced current generated when the first motor 22R rotates rearward. The second current sensor SW2 detects an induced current with the same sign as the induced current generated when the second motor 22L rotates forward.

The controller 4 according to the present embodiment is configured to assist the movement in the forward direction, that is, the direction in which the external force acts, by feeding back the torque related to the induced current (more specifically, by rotating the first and second motors 22R and 22L at the commanded rotational speeds corresponding to the torque).

The first and second rotation sensors SW3 and SW4 respectively detect the rotational speeds of the first and second motors 22R and 22L. Specifically, the first and second rotation sensors SW3 and SW4 according to the present embodiment are each constituted of an encoder. The first rotation sensor SW3 serving as the encoder detects the speed and angle of rotation of the first motor 22R, and the second rotation sensor SW4 also serving as the encoder detects the speed and angle of rotation of the second motor 22L.

As shown in FIG. 8, the six-axis sensor SW5 can detect accelerations in three directions along an x-axis extending in the front-rear direction, a y-axis extending in the left-right direction, and the z-axis extending in the vertical direction, an angular velocity of a rotation angle about the x-axis (so-called roll angle φ), an angular velocity of a rotation angle about the y-axis (so-called pitch angle θ), and an angular velocity of a rotation angle about the z-axis (so-called yaw angle ψ). A detection signal of the six-axis sensor SW5 is inputted to the controller 4.

The controller 4 controls the first and second motors 22R and 22L based on the electrical signals inputted from the sensors SW1 to SW5. The controller 4 includes a CPU, memory, and an input/output bus, and is constituted of, for example, a control board.

More specifically, the controller 4 commands the rotational speeds of the first and second motors 22R and 22L based on the detection signals inputted from the sensors SW1 to SW5. The controller 4 inputs motor currents corresponding to the commanded rotational speeds to the first and second motors 22R and 22L. The first and second motors 22R and 22L rotate at the rotational speeds commanded by the controller 4.

The first mecanum wheel 21R rotates at the same rotational speed as the first motor 22R, and the second mecanum wheel 21L rotates at the same rotational speed as the second motor 22L. That is, setting the commanded rotational speeds of the first and second motors 22R and 22L is equivalent to setting the commanded rotational speeds of the first and second mecanum wheels 21R and 21L.

By changing the signs of the commanded rotational speeds, the directions of rotation of the first motor 22R and the second motor 22L can be individually changed. By changing the rotation directions of the motors 22R and 22L, the corresponding mecanum wheels 21R and 21L can be switched between forward rotation and rearward rotation.

In the present embodiment, when the first mecanum wheel 21R located on the right rotates forward, a thrust can be exerted on the transport assistance apparatus 1 and the bed 10 obliquely forward to the left (see an arrow A11 in FIG. 7). When the second mecanum wheel 21L located on the left rotates forward, the transport assistance apparatus 1 can exert a thrust to the bed 10 obliquely forward to the right (see an arrow A12 in FIG. 7).

Thus, as shown in an upper left part of FIG. 7, for example, when both the first and second mecanum wheels 21R and 21L rotate forward, the thrust to the left exerted by the forward rotation of the first mecanum wheel 21R and the thrust to the right exerted by the forward rotation of the second mecanum wheel 21L cancel each other out, allowing the entire transport assistance apparatus 1 to generate a thrust to the front. This thrust can assist the bed 10 to move forward.

Similarly, when the first mecanum wheel 21R located on the right rotates rearward, a thrust can be exerted on the transport assistance apparatus 1 and the bed 10 obliquely rearward to the right (see an arrow A21 in FIG. 7). When the second mecanum wheel 21L located on the left rotates rearward, the transport assistance apparatus 1 can exert a thrust to the bed 10 obliquely rearward to the left (see an arrow A22 in FIG. 7).

Thus, as shown in an upper right part of FIG. 7, for example, when both the first and second mecanum wheels 21R and 21L rotate rearward, the thrust to the right exerted by the rearward rotation of the first mecanum wheel 21R and the thrust to the left exerted by the rearward rotation of the second mecanum wheel 21L cancel each other out, allowing the entire transport assistance apparatus 1 to generate a thrust to the rear. This thrust can assist the bed 10 to move rearward.

When one of the first and second mecanum wheels 21R and 21L rotates forward and the other rotates rearward, the transport assistance apparatus 1 can exert a thrust to the bed 10 in the left-right direction.

In an example shown in a lower left part of FIG. 7, the first mecanum wheel 21R rotates rearward, and the second mecanum wheel 21L rotates forward, applying a thrust to the right to the bed 10.

When one of the first and second mecanum wheels 21R and 21L rotates forward and the other rotates rearward, the transport assistance apparatus 1 can exert a thrust to the bed 10 in an oblique direction.

In an example shown in a lower right part of FIG. 7, the forward rotation of the second mecanum wheel 21L alone can move the bed 10 obliquely forward to the right. This thrust can assist the oblique movement of the bed 10. The forward rotation of the first mecanum wheel 21R alone can assist the bed 10 to move obliquely forward to the left (not shown).

The transport assistance apparatus 1 is configured to assist the transporter 100 in transporting the bed 10 with the thrust applied as described above by operating the first and second motors 22R and 22L based on the detection signals of the sensors SW1 to SW5.

To provide such assistance, the controller 4 according to the present embodiment determines a direction in which the external force acts (hereinafter, also simply referred to as an “acting direction”) based on the detection signals of the sensors SW1 to SW5, and operates the first and second motors 22R and 22L to exert a thrust in the acting direction.

For example, when the headboard 11h is pushed from the rear side toward the front side and it is determined that an external force is acting from the rear side toward the front side, the controller 4 rotates both the first and second motors 22R and 22L forward to rotate both the first and second mecanum wheels 21R and 21L forward. This can assist the forward movement of the bed 10 as illustrated in the upper left part of FIG. 7.

The first and second mecanum wheels 21R and 21L are allowed to rotate forward and rearward when the corresponding motors 22R and 22L are not driven. This can reduce wobbling of the bed 10 being moved by hand, stabilizing the conveyance of the bed 10.

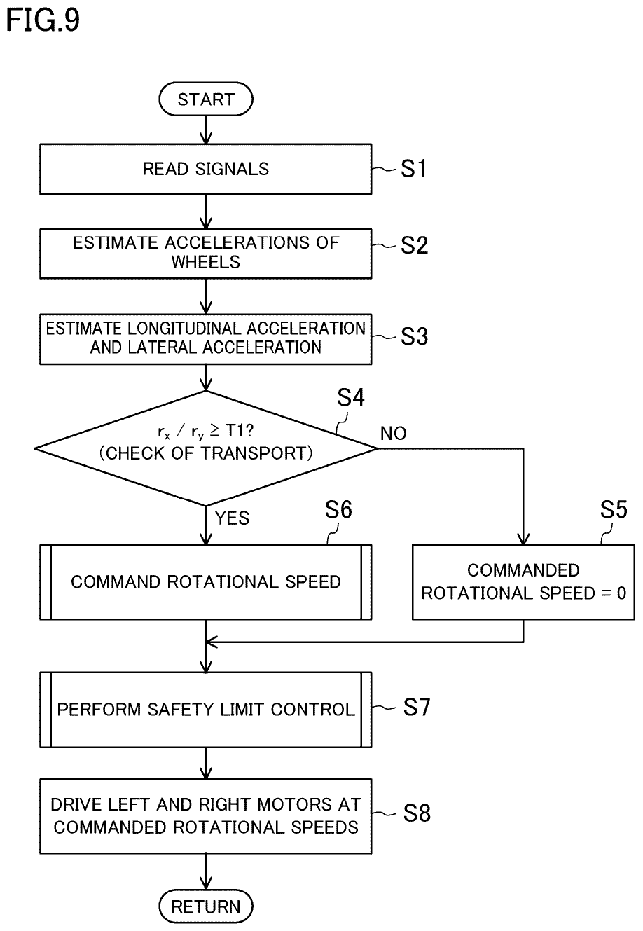

The assistance by the controller 4 will be described in detail below with reference to FIG. 9 and some other drawings.

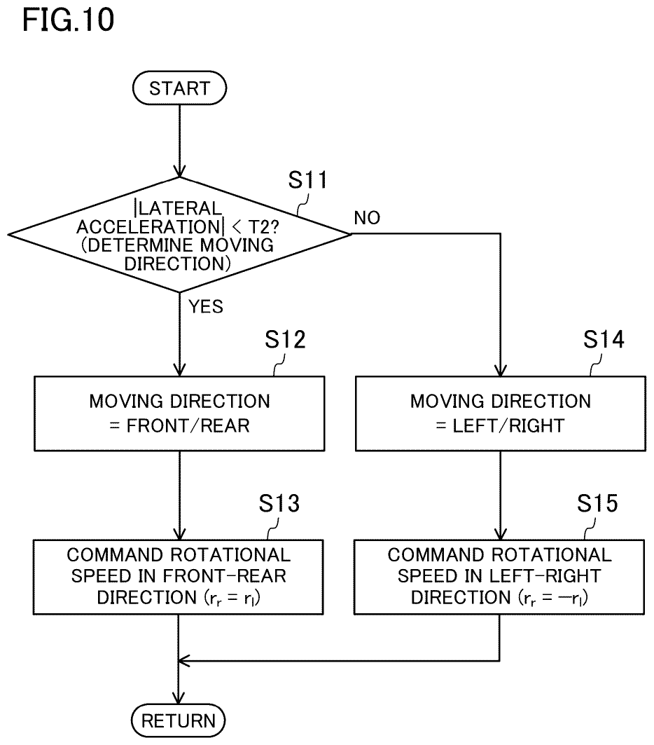

FIG. 9 is a flowchart of a major process performed by the controller 4. FIG. 10 is a flowchart of a process related to the determination of a moving direction. FIG. 11 is a flowchart illustrating safety limit control.

First, in Step S1 of FIG. 9, the controller 4 reads the detection signals of the five sensors SW1 to SW5 described above.

In the subsequent Step S2, the controller 4 individually estimates the accelerations of the first and second mecanum wheels 21R and 21L based on the detection signals of the first and second current sensors SW1 and SW2.

Hereinafter, the acceleration of the first mecanum wheel 21R is referred to as a “first acceleration,” and the acceleration of the second mecanum wheel 21L is referred to as a “second acceleration.” Both the first and second accelerations are time derivatives of the translational velocity, that is, so-called tangential accelerations.

The magnitude of the induced current detected by each of the first and second current sensors SW1 and SW2 is proportional to torque acting on the first and second mecanum wheels 21R and 21L (particularly, the torque caused by the reactive force) during the rotation of the wheels. The controller 4 individually estimates first torque acting on the first mecanum wheel 21R and second torque acting on the second mecanum wheel 21L based on the proportional relationship. At this time, a factor of proportionality for converting the induced current to the torque stored in the controller 4 in advance may be used.

The controller 4 according to the present embodiment assists the movement of the bed 10 by driving the first and second motors 22R and 22L against the reactive forces corresponding to the first and second torques.

To provide such assistance, the controller 4 estimates the first acceleration corresponding to the first torque and the second acceleration corresponding to the second torque based on the following expressions (1) and (2).

$${a}_{r} = ( - 1 ) \cdot {T}_{r} / ( R \cdot m ) \qquad ( 1 )$$

$${a}_{l} = ( - 1 ) \cdot {T}_{l} / ( R \cdot m ) \qquad ( 2 )$$

In the above expressions (1) and (2), Tr [Nm] is the first torque, and T₁ [Nm] is the second torque. Further, aᵣ [m/s²] is the first acceleration corresponding to the first torque, and aₗ [m/s²] is the second acceleration corresponding to the second torque.

R [m] is the tire radius of each of the first and second mecanum wheels 21R and 21L, and m [kg] is the mass of each of the first and second mecanum wheels 21R and 21L. The first and second mecanum wheels 21R and 21L of the present embodiment have the same tire radius R and mass m.

In the subsequent step S3, the controller 4 estimates translational accelerations of the first and second mecanum wheels 21R and 21L based on the detection signals of the first and second current sensors SW1 and SW2.

Specifically, the controller 4 estimates a longitudinal acceleration indicating the translational acceleration of the first and second mecanum wheels 21R and 21L in the front-rear direction and a lateral acceleration indicating the translational acceleration of the first and second mecanum wheels 21R and 21L in the lateral direction using the first and second accelerations aᵣ and aₗ estimated based on the detection signals of the first and second current sensors SW1 and SW2.

Specifically, when the first and second mecanum wheels 21R and 21L are configured as shown in FIGS. 3 to 5, the controller 4 estimates the longitudinal acceleration by adding the first acceleration aᵣ and the second acceleration aₗ, and estimates the lateral acceleration by calculating a difference between the first acceleration aᵣ and the second acceleration aₗ. The following expressions (3) and (4) show the details of these operations.

$${a}_{x} = ( {a}_{r} + {a}_{l} ) / 2 \qquad ( 3 )$$

$${a}_{y} = ( {a}_{l} - {a}_{r} ) / 2 \qquad ( 4 )$$

In the above expressions (3) and (4), aₓ [m/s²] is the longitudinal acceleration, and a_{y} [m/s²] is the lateral acceleration. The left side of the expression (3) is defined as positive and the right side is defined as negative. The positive and negative signs may be reversed between the left and right sides. Similarly, the left side of the expression (4) is defined as positive and the right side is defined as negative. The positive and negative signs may be reversed between the left and right sides.

That is, each of the first and second accelerations aᵣ and aₗ has a component in the front-rear direction and a component in the left-right direction. With the first and second mecanum wheels 21R and 21L configured and arranged as in the present embodiment, the components in the front-rear direction of the first mecanum wheel 21R and the second mecanum wheel 21L have the same sign, and the components in the left-right direction of the first mecanum wheel 21R and the second mecanum wheel 21L have the reverse signs.

Thus, the components in the left-right direction can be canceled out by the expression (3), and the components in the front-rear direction can be extracted and averaged. Similarly, the components in the front-rear direction can be canceled out by the expression (4), and the components in the left-right direction can be extracted and averaged. The translational acceleration of the first and second mecanum wheels 21R and 21L as a whole can be estimated by the expressions (3) and (4).

The relational expressions such as the expressions (3) and (4) are also satisfied for the rotational speeds of the first and second motors 22R and 22L (i.e., the rotational speeds of the first and second mecanum wheels 21R and 21L).

Here, rᵣ [rpm] is the rotational speed of the first motor 22R in the front-rear direction (hereinafter also referred to as a “first rotational speed”), and r₁ [rpm] is the rotational speed of the second motor 22L in the front-rear direction (hereinafter also referred to as a “second rotational speed”). Among these rotational speeds, the first rotational speed rᵣ is detected by the first rotation sensor SW3, and the second rotational speed r₁ is detected by the second rotation sensor SW4.

Further, rₓ [rpm] is the rotational speed of the first and second motors 22R and 22L as a whole in the front-rear direction (hereinafter, also referred to as a “longitudinal rotational speed”), and r_{y} [rpm] is the rotational speed of the first and second motors 22R and 22L as a whole in the left-right direction (hereinafter, also referred to as a “lateral rotational speed”). When the first and second mecanum wheels 21R and 21L are configured and arranged as in the present embodiment, the following expressions (5) and (6) are satisfied.

$${r}_{x} = ( {r}_{r} + {r}_{l} ) / 2 \qquad ( 5 )$$

$${r}_{y} = ( {r}_{r} - {r}_{l} ) / 2 \qquad ( 6 )$$

The expressions (5) and (6) can be modified to the following expressions (7) and (8). As shown in the expressions (7) and (8), rᵣ and r₁ can be uniquely determined by setting rₓ and r_{y}.

$${r}_{r} = {r}_{x} + {r}_{y} \qquad ( 7 )$$

$${r}_{l} = {r}_{x} - {r}_{y} \qquad ( 8 )$$

Subsequently, the controller 4 permits the driving of the first and second mecanum wheels 21R and 21L on condition that the rotational speeds of the first and second mecanum wheels 21R and 21L are equal to or greater than a predetermined first threshold based on the detection signals of the first and second rotation sensors SW3 and SW4.

Specifically, in Step S4 following Step S3, the controller 4 determines whether either one of the following relational expressions (9) and (10) is satisfied. Whether the bed 10 is actually being transported can be checked by this determination (check of conveyance).

$${r}_{x} \geq T 1 \qquad ( 9 )$$

$${r}_{y} \geq T 1 \qquad ( 10 )$$

In the expressions (9) and (10), T₁ [1/s] is the first threshold. The magnitude of the first threshold is stored in advance in the memory of the controller 4. The first threshold in the expression (9) and the first threshold in the expression (10) are equal. As described above, “rₓ/r_{y}” in Step S4 of FIG. 9 means “either one of rₓ or r_{y}” rather than “a quotient of rₓ by r_{y}.”

If both of the expressions (9) and (10) are not satisfied, the controller 4 determines that the bed 10 is not being transported by the external force, and does not allow the driving of the first and second motors 22R and 22L (Step S4: NO). In this case, the control process proceeds to Step S5. In Step S5, the controller 4 sets the commanded rotational speeds of the first and second motors 22R and 22L to zero.

When the process proceeds to Step S5, the commanded rotational speeds of the first and second motors 22R and 22L are set to zero in the subsequent Steps S7 and S8 (details of Steps S7 and S8 will be described later). In this case, the controller 4 ends the flow shown in FIG. 9 without driving the first and second motors 22R and 22L.

If at least one of the expressions (9) and (10) is satisfied, the controller 4 determines that the bed 10 is actually being transported by the external force, and permits the driving of each of the first and second motors 22R and 22L (Step S4: YES). In this case, the control process proceeds to Step S6. In Step S6, the controller 4 commands the respective rotational speeds of the first and second motors 22R and 22L to assist the hand-propelled movement by the external force.

Steps S11 to S15 in FIG. 10 illustrate the process performed in Step S6 of FIG. 9. That is, when the control process proceeds to Step S6, the controller 4 starts Step S11 of FIG. 10.

In Steps S11 to S13 described below, the controller 4 determines the moving direction of the bed 10 based on the first and second accelerations aᵣ and an estimated in Step S2 of FIG. 9. Specifically, the controller 4 according to the present embodiment determines whether the moving direction of the bed 10 is the front-rear direction and whether the moving direction of the bed is the left-right direction based on the first and second accelerations aᵣ and aₗ.

More specifically, the controller 4 according to the present embodiment determines the moving direction of the bed 10 based on the magnitude of the difference between the first acceleration aᵣ and the second acceleration aₗ (lateral acceleration a_{y}) calculated in Step S3 of FIG. 9.

In particular, in Step S11 of FIG. 10, the controller 4 determines whether the following relational expression (11) is satisfied.

$$\vert {a}_{y} \vert < T 2 \qquad ( 11 )$$

In the expression (11), T2 [m/s²] is a second threshold. The magnitude of the second threshold is stored in advance in the memory of the controller 4, and is suitably read out when necessary.

If the above expression (11) is satisfied (Step S11: YES), the controller 4 advances the control process to Step S12. In Step S12, the controller 4 determines that “the moving direction=the front-rear direction.”

In Step S12, the controller 4 determines whether the moving direction is the front (aₓ>0) or the rear (aₓ<0) based on the sign of the longitudinal acceleration aₓ. When this determination is completed, the controller 4 advances the control process to Step S13.

If the above expression (11) is not satisfied (Step S11: NO), the controller 4 advances the control process to Step S14. In Step S14, the controller 4 determines that “the moving direction=the left-right direction.”

In Step S14, the controller 4 determines whether the moving direction is the left (a_{y}>0) or the right (a_{y}<0) based on the sign of the lateral acceleration a_{y}. When this determination is completed, the controller 4 advances the control process to Step S15.

In Steps S13 and S15, the controller commands 4 the respective rotational speeds of the first and second motors 22R and 22L based on the determination performed in Step S12 or S14 to assist the movement of the bed 10 in the moving direction.

In particular, in Step S13 performed when it is determined that the moving direction is the front-rear direction, the controller 4 commands the rotational speeds of the first and second motors 22R and 22L to rotate both the first and second mecanum wheels 21R and 21L forward or backward. When commanding, the controller 4 makes the absolute values of the commanded rotational speeds of the first motor 22R and the second motor 22L equal to each other. The sign of each commanded rotational speed is defined to be positive when the motor rotates forward, and negative when the motor rotates rearward.

Suppose the commanded rotational speed of the first motor 22R (hereinafter also referred to as a first commanded rotational speed) is Rᵣ and the commanded rotational speed of the second motor 22L (hereinafter also referred to as a second commanded rotational speed) is Rₗ, the transport assistance apparatus 1 according to the present embodiment sets the commanded rotational speeds to satisfy the following expression (12) when the moving direction is the front, and to satisfy the following expression (13) when the moving direction is the rear.

$${R}_{r} = {R}_{l} > 0 \qquad ( 12 )$$

$${R}_{r} = {R}_{l} < 0 \qquad ( 13 )$$

In Step S15 performed when it is determined that the moving direction is the left-right direction, the controller 4 commands the rotational speeds of the first and second motors 22R and 22L so that one of the first and second mecanum wheels 21R and 21L rotates forward and the other rotates rearward. When commanding, the controller 4 makes the absolute values of the commanded rotational speeds of the first motor 22R and the second motor 22L equal to each other.

Thus, in the transport assistance apparatus 1 according to the present embodiment, the following expression (14) is satisfied when the moving direction is the left, and the following expression (15) is satisfied when the moving direction is the right.

$${R}_{r} = - {R}_{l} > 0 \qquad ( 14 )$$

$${R}_{l} = - {R}_{r} > 0 \qquad ( 15 )$$

When the processes of Steps S13 and S15 of FIG. 10 are completed, the control process proceeds to Step S7 of FIG. 9. In Step S7, the controller 4 performs a safety control process. Details of this process are shown in Steps S31 and S32 of FIG. 11.

In Step S31, the controller 4 determines whether the absolute values of the commanded rotational speeds Rᵣ and Rₗ set through the flow of FIG. 10 are equal to or greater than a predetermined third threshold T3. The magnitude of the third threshold T3 is stored in advance in the memory of the controller 4, and is suitably read out as needed.

If the determination at Step S31 is YES, the controller 4 advances the control process to Step S32. In Step S32, the controller 4 changes the commanded rotational speeds Rᵣ and Rₗ to the third threshold T3.

If NO is selected in the determination of Step S32, the controller 4 skips Step S32 and returns. In this case, the magnitudes of the commanded rotational speeds Rᵣ and Rₗ are maintained to be less than the third threshold T3.

Then, in Step S8 following Step S7 in FIG. 9, the controller 4 drives the first and second mecanum wheels 21R and 21L via the first and second motors 22R and 22L to assist the movement of the bed 10 in the moving direction. At this time, the first and second motors 22R and 22L are driven to reach the commanded rotational speeds Rᵣ and Rₗ determined in Steps S5, S6, and S7. This provides the assistance in the moving direction of the bed 10.

As described above, use of the two mecanum wheels 21R and 21L allows the rotation direction of each of the mecanum wheels 21R and 21L to be associated with the translation direction on the xy plane (see FIG. 7). The translational direction of the transport assistance apparatus 1 itself is considered to substantially coincide with the direction in which the external force acts, and thus, the moving direction of the bed 10. Based on the rotation directions of the mecanum wheels 21R and 21L, the moving direction of the entire bed 10 can be determined. By assisting the movement in the determined moving direction, the actual rotation statuses of the mecanum wheels 21R and 21L are reflected, providing better assistance.

Further, as illustrated in FIG. 7, the translational direction of the entire transport assistance apparatus 1 can be different between when both the first and second mecanum wheels 21R and 21L rotate in the same direction and when the first and second mecanum wheels 21R and 21L rotate in different directions. The rotation directions of the mecanum wheels 21R and 21L are clearly distinguished from each other according to the translational direction, allowing more accurate determination of the moving direction of the bed 10. This is advantageous in providing better assistance in moving the bed 10.

As illustrated in FIG. 7, when both the first and second mecanum wheels 21R and 21L rotate in the same direction, the entire transport assistance apparatus 1 translates in the front-rear direction. When the first and second mecanum wheels 21R and 21L rotate in different directions, the entire transport assistance apparatus 1 translates in the left-right direction. The rotation directions of the mecanum wheels 21R and 21L during the front-rear movement and the rotation directions of the mecanum wheels 21R and 21L during the left-right movement are clearly distinguished from each other, allowing more accurate determination of the moving direction of the bed 10. This is advantageous in providing better assistance in moving the bed 10.

When both the first and second mecanum wheels 21R and 21L rotate in the same direction (i.e., during the translation in the front-rear direction), the lateral acceleration a_{y} is substantially zero. When the first and second mecanum wheels 21R and 21L rotate in different directions, the lateral acceleration a_{y} is significantly larger than zero. The magnitude of the difference during the front-rear movement and the magnitude of the difference during the left-right movement are clearly distinguished from each other, and as illustrated in Steps S11, S12, and S14 in FIG. 10, the moving direction of the bed 10 can be determined more accurately. This is advantageous in providing better assistance in moving the bed 10.

Further, as described with reference to Step S13 in FIG. 10, the absolute values of the commanded rotational speeds of the left and right motors are made equal to each other for the front-rear movement, allowing more stable front-rear movement regardless of the orientation of the bed 10. This is advantageous in providing better assistance in moving the bed 10.

Further, as described with reference to Step S15 in FIG. 10, the absolute values of the commanded rotational speeds of the left and right motors are made equal to each other for the left-right movement, allowing more stable left-right movement regardless of the orientation of the bed 10. This is advantageous in providing better assistance in moving the bed 10.

The transport assistance apparatus 1 according to the present embodiment can also provide better assistance in moving a heavy object such as a bed with casters.

### Other Embodiments

In the above embodiment, it has been described that the transport assistance apparatus includes a pair of mecanum wheels, but the present disclosure is not limited to such a configuration. For example, the transport assistance apparatus may include a plurality of mecanum wheels such as third and fourth mecanum wheels in addition to the first and second mecanum wheels 21R and 21L that can be used to determine the moving direction of the bed 10.

In the above embodiment, it is determined whether the moving direction of the bed 10 is the front-rear direction or the left-right direction, but the present disclosure is not limited to such a configuration. For example, when both the longitudinal acceleration aₓ and the lateral acceleration a_{y} are equal to or greater than a predetermined value, it may be determined that the bed 10 is moving in an oblique direction. As illustrated in the lower right part of FIG. 7, the movement in the oblique direction can be assisted by using a thrust generated by rotating one of the first and second mecanum wheels 21R and 21L forward or rearward.

For the determination regarding the movement in the oblique direction, it is only necessary to determine whether the following expression (16) is satisfied, for example, between Steps S11 and S14 in FIG. 10.

|aₓ|<T2 (16)

When the determination of the expression (16) is YES, the controller 4 determines that the moving direction of the bed 10 is the left-right direction, and advances the control process to Step S14 to perform the above-described process. When the determination of the expression (16) is NO, the controller 4 determines that the bed 10 is moving in the oblique direction, and may perform the process of rotating one of the first and second mecanum wheels 21R and 21L forward or rearward as described above.

For the assistance of the oblique movement, it is only necessary to determine in Step S4 in FIG. 9 whether at least one of the expressions (9) and (10) is satisfied, instead of determining whether either one of the expressions (9) and (10) is satisfied. For example, when the bed 10 is moving in the oblique direction, both the expressions (9) and (10) are satisfied.

### DESCRIPTION OF REFERENCE CHARACTERS

1 Transport Assistance Apparatus
4 Controller
10 Bed (Target)
14 Caster
14F Front Caster
14B Rear Caster
21R First Mecanum Wheel
211R First Wheel Body
212R First Barrel-Shaped Roller
21L Second Mecanum Wheel
211L Second Wheel Body
212L Second Barrel-Shaped Roller
22R First Motor
22L Second Motor
Oy1 First Rotation Axis
Oy2 Second Rotation Axis
Or First Inclined Axis
Ol Second Inclined Axis
SW1 First Current Sensor
SW2 Second Current Sensor

1. A transport assistance apparatus for assisting a movement of a target made by an external force, the transport assistance apparatus comprising:
a first mecanum wheel and a second mecanum wheel that are attached to the target;
a first motor and a second motor that are respectively connected to the first mecanum wheel and the second mecanum wheel to drive the first mecanum wheel and the second mecanum wheel;
a first current sensor that detects an induced current flowing through the first motor when the first mecanum wheel rotates, and a second current sensor that detects an induced current flowing through the second motor when the second mecanum wheel rotates; and
a controller that controls the first and second motors,
wherein
the controller
individually estimates accelerations of the first and second mecanum wheels based on detection signals of the first and second current sensors,
determines a moving direction of the target based on the accelerations of the first and second mecanum wheels, and
drives the first and second mecanum wheels via the first and second motors to assist the movement of the target in the moving direction.

2. The transport assistance apparatus of claim 1, wherein
the first mecanum wheel includes
a first wheel body that rotates about a first rotation axis and
a plurality of first barrel-shaped rollers arranged along an outer periphery of the first wheel body and rotating about a first inclined axis inclined with respect to the first rotation axis, and
the second mecanum wheel includes
a second wheel body that rotates about a second rotation axis extending parallel to the first rotation axis and
a plurality of second barrel-shaped rollers arranged along an outer periphery of the second wheel body and rotating about a second inclined axis inclined in a direction different from the first inclined axis with respect to the second rotation axis.

3. The transport assistance apparatus of claim 2, wherein
both the first and second rotation axes extend in a left-right direction that is orthogonal to a front-rear direction of the target and extends parallel to a transport surface on which the target travels, and
the first inclined axis is inclined to be line-symmetrical with the second inclined axis with respect to the front-rear direction.

4. The transport assistance apparatus of claim 3, wherein
the controller
calculates a difference between the acceleration of the first mecanum wheel and the acceleration of the second mecanum wheel, and
determines the moving direction based on a magnitude of the difference.

5. The transport assistance apparatus of claim 3, wherein
the controller
determines whether the moving direction is the front-rear direction based on the accelerations of the first and second mecanum wheels, and
commands rotational speeds of the first and second motors so that both the first and second mecanum wheels rotate forward or rearward when it is determined that the moving direction is the front-rear direction, and when commanding the rotational speeds, makes absolute values of the commanded rotational speeds of the first and second motors equal to each other.

6. The transport assistance apparatus of claim 3, wherein
the controller
determines whether the moving direction is the left-right direction based on the accelerations of the first and second mecanum wheels, and
commands rotational speeds of the first and second motors so that one of the first and second mecanum wheels rotates forward and the other rotates rearward when it is determined that the moving direction is the left-right direction, and when commanding the rotational speeds, makes absolute values of the commanded rotational speeds of the first and second motors equal to each other.

7. The transport assistance apparatus of claim 1, wherein
the target is a bed with casters, and
the first and second mecanum wheels are attached to a lower portion of the bed with casters.
